(19) United States
(12) Patent Application Publication
(10) Pub. No.: US 2019/0141951 A1
(43) Pub. Date: May 16, 2019

(54) GARMENT FOR ANIMALS

(71) Applicant: Christopher Coughlan, La Mesa, CA (US)

(72) Inventor: Christopher Coughlan, La Mesa, CA (US)

(21) Appl. No.: 16/164,233

(22) Filed: Oct. 18, 2018

Related U.S. Application Data
(63) Continuation-in-part of application No. 29/663,789, filed on Sep. 19, 2018.
(60) Provisional application No. 62/584,648, filed on Nov. 10, 2017.
(60) Provisional application No. 62/584,648, filed on Nov. 10, 2017.

(51) Int. Cl. A01K 13/00; A01K 15/00; D04B 1/22; D04B 21/20

(52) U.S. Cl. CPC A01K 13/006; A01K 15/00; D04B 1/22; D10B 2401/061; D10B 2331/021; D10B 2331/12; D04B 21/20

(57) ABSTRACT

A form fitting garment for an animal. In one aspect, the garment provides constant, gentle presure to the animal in order to induce calm or reduce anxiety in the animal. In another aspect the garment is designed to be slipped on to the animal, and requires no straps, fasteners, or pull-strings to achieve a desired fit. In another aspect, the garment is designed to withstand the rigors of outdoor use. In another aspect, the garment is consistent with aquatic use.

### RELATED APPLICATION(S)

This application claims the benefit of U.S. patent application Ser. No. 62/584,648 filed Nov. 10, 2017 and U.S. patent application Ser. No. 29/663,789 filed Sep. 19, 2018 in the name of the same inventor, Christopher Coughlan.

### FIELD OF THE INVENTION

The present invention relates to garments for animals, and more particularly to protective garments for dogs.

### BACKGROUND

Animals in general, and domesticated pets in particular, are susceptible to many of the same fears and anxieties that trouble man. For many pets, simple daily experiences such as passing traffic, knocks on the door, and inclement weather induce a state of anxiousness, and even outright panic. The result is often unwanted behavior from the animal, such as uncontrolled barking. These negative behaviors are inconvenient in a domestic setting, but can completely ruin an outing if they occur while hunting or hiking with the animal.

For some time, veterinarians have recognized that the application of constant, gentle pressure to an animal reduces the apparent anxiety that the animal is experiencing. As such, numerous products have been introduced to the market, such as those described in U.S. Pat. Nos. 8,291,867 and 6,820,574. However, such devices have numerous disadvantages. First, they primarily rely on wrap-based technology, which must be fitted onto the animal and adjusted with each use to ensure that proper pressure is being applied. If the wrap is too loose, the device will not achieve its intended calming effect. If the wrap is too tight, the animal will experience discomfort and potentially an increase in anxiety. Furthermore, these devices are rather bulky, and thus not intended for constant use on the animal, instead only being deployed in times of need.

Alternate shirts exist which proport to exert constant pressure to the animal, however such garments are constructed in such a way that they never achieve a true form-fit on the animal. The sloppy fit of these garments ensures that they never provide adequate pressure to ensure a calm state in the animal, and often result in the animal attempting to remove the garment. The primary cause of this problem lies in the construction of these garments, which relies on a single type of fabric to construct the entire garment. While some garments attempt to overcome this defect by including draw-strings in order to achieve the desired fit (see U.S. Pat. No. 6,820,574), using such constricting straps are inconvenient, and run the same risks regarding over- and under-tightening discussed above.

Furthermore, none of the calming garments currently available are designed to withstand the rigors of prolonged out-door use. The removable nature of the above described anxiety wraps makes it likely that they will come loose should the animal run through brush or undergrowth. Furthermore, none of the above-mentioned garments are designed to function after being fully submerged in water.

As such, there is a need for a garment that applies calming pressure to an animal, which may be easily placed on an animal without the need to worry about properly adjusting the garment, which may be left on for a prolonged period of time (or even indefinitely), and which may be specialized for sport or outdoor use.

### SUMMARY OF THE INVENTION

The above discussed disadvantages of the prior art are overcome by the garment of the present invention, which provides constant gentle pressure to the torso of the animal and is convenient and easy to use.

Thus, it is one aspect of the present invention to provide a garment, that when properly sized for the animal, provides constant pressure to the animal through the action of the fabrics of which the garment is comprised, and not through the use of additional adjustments, straps, or other means. Thus, a person tending to the animal will not have to concern themselves with the possibility of over- or under-tightening the garment to achieve the proper pressure on the animal.

It is another aspect of some embodiments of the present invention to provide a garment that is made of durable fabrics able to withstand moderate to extreme out-door use. Such fabrics may be selected for their rip or tear resistance, or for specific properties such as insulation, moisture wicking, or enhanced buoyancy. Thus, in addition to promoting calm within the animal, the garment may enhance the performance, endurance, and/or comfort of the animal during activities such as hunting and hiking.

It is yet another aspect of certain embodiments of the present invention to provide a garment with an embedded tracking system, allowing the animal to be located should it become lost or otherwise separated from its owner. Such tracking systems include devices that make use of the global positioning system (GPS), radio beacons, and other such systems that are known in the art. Such systems may be integral to the garment itself, or may be added into a pocket or pouch in the garment by the user at a later date.

Thus, it one embodiment of the present invention to provide a form fitting, substantially tubular garment for an animal having a front end, a back end, a dorsal side, and a ventral side, said garment comprising: a first fabric and a second fabric; wherein said dorsal side comprises said first fabric; wherein said first fabric comprises a material expandable in at least one dimension; wherein said ventral side comprises said second fabric; and wherein said second fabric comprises a material expandable in at least two dimensions; wherein said front end of said garment comprises an opening to accommodate the head of said animal; wherein said ventral side of said garment further comprises openings substantially near the front end of said garment to accommodate the fore-limbs of said animal.

It is another embodiment of the present invention to provide such a garment, wherein at least one of the material expandable in at least one dimension and the material expandable in at least two dimensions is resistant abrasive force.

It is yet another embodiment of the present invention to provide such a garment, wherein at least one of the material expandable in at least one dimension and the material expandable in at least two dimensions is a rip-stop material.

It is still another embodiment of the present invention to provide such a garment, wherein at least one of the material expandable in at least one dimension and the material expandable in at least two dimensions is a rash-guard material.

It is yet another embodiment of the present invention to provide such a garment, wherein at least one of the material expandable in at least one dimension and the material expandable in at least two dimensions is a moisture wicking material.

It is still another embodiment of the present invention to provide such a garment, wherein the garment applies a constant pressure to the animal.

It is yet another embodiment of the present invention to provide such a garment, wherein the garment further comprises a pocket.

It is still another embodiment of the present invention to provide such a garment, wherein said pocket is configured to receive a locating device.

It is yet another embodiment of the present invention to provide such a garment, wherein the garment lacks fasteners and pull-strings.

It is another embodiment of the present invention to provide a method for reducing anxiety in an animal, the method comprising: identifying an animal at risk of anxiety; and placing on said animal a form fitting, substantially tubular garment having a front end, a back end, a dorsal side, and a ventral side, said garment comprising: a first fabric and a second fabric; wherein said dorsal side comprises said first fabric; wherein said first fabric comprises a material expandable in at least one dimension; wherein said ventral side comprises said second fabric; wherein said second fabric comprises a material expandable in at least two dimensions; wherein said front end of said garment comprises an opening to accommodate the head of said animal; and wherein said ventral side of said garment further comprises openings substantially near the front end of said garment to accommodate the fore-limbs of said animal.

These, and other, embodiments of the invention will be better appreciated and understood when considered in conjunction with the following description and the accompanying tables. It should be understood, however, that the following description, while indicating various embodiments of the invention and numerous specific details thereof, is given by way of illustration and not of limitation. Many substitutions, modifications, additions and/or rearrangements may be made within the scope of the invention without departing from the spirit thereof, and the invention includes all such substitutions, modifications, additions and/or rearrangements.

### DESCRIPTION OF THE FIGURES

FIG. 1: A lateral view of one embodiment of the garment of the present invention on a dog.

FIG. 2: A lateral view of one embodiment of the garment of the present invention.

FIG. 3. A dorsal view of one embodiment of the garment of the present invention.

FIG. 4. A ventral view of one embodiment of the garment of the present invention.

FIG. 5. A lateral view of an alternate embodiment of the garment of the present invention on a dog.

FIG. 6. A lateral view of an alternate embodiment of the garment of the present invention.

FIG. 7. A lateral view of an alternate embodiment of the garment of the present invention

### DETAILED DESCRIPTION OF THE INVENTION

Unless otherwise defined, all terms used herein have the same meaning as commonly understood by one of ordinary skill in the art to which this invention belongs. Methods and materials are described herein for use of the present invention; other suitable methods and materials known in the art can also be used. The materials and methods, and examples are illustrative only and not intended to be limiting. All publications, patent applications, patents, and other references mentioned herein are incorporated by reference in their entirety. In case of conflict, the present specification including definitions will control.

Definitions:

The term “animal” is used to refer to any creature which may make use of the garment. Although the figures focus on the use of the garment by a canine, the garment may also be used by, for example, a cat, a horse, a monkey, or a penguin.

An article of clothing is “form fitting” if it fits the body of the wearer snuggly, such that the underlying body shape of the wearer is substantially distinguishable by an observer.

A “material expandable in at least one dimension” includes, by way of example, 2-way stretch fabrics and other such materials that, when force is applied, expand in one direction, usually from selvedge to selvedge. Conversely, such materials are substantially not expandable in the cross-wise direction, regardless of the amount of force applied. Such 2-way stretch fabrics revert to their original dimensions when the force is removed. Example of such fabrics include, by way of example and not limitation, cotton knits with lycra, polyester performance knits, and other materials known in the art.

A “material expandable in a least two dimensions” includes, by way of example, 4-way stretch fabrics and other such materials that, when force is applied, expand both cross-wise and length-wise along the material and that return to their original dimensions upon removal of the force. Such 4-way stretch fabrics include, by way of example and not limitation, polyester knits with lycra, nylon and spandex knits, nylon and lycra knits, and other such materials known in the art.

A key feature of certain embodiments of the present invention is the use of two different fabrics, each of which possess different properties, to construct a garment that is both form fitting and capable of exerting constant gentle pressure on the wearer along substantially all of its surface area. Preferably, the pressure will be sufficient to reduce anxiety within the animal. In certain embodiments, if properly sized to the animal, the garment may be slipped onto the animal without the need for any straps, fasteners, or pull strings to ensure a proper fit.

It will be apparent to those having skill in the art that different types of fabric may be selected to improve various properties of the garment. By way of example, in certain embodiments of the present invention, a durable fabric may be used, which includes any fabric that is resistant to at least one of ripping, tearing, fraying, or other such abrasive force. Such durability may be achieved through enhanced elasticity, or through other means, such as those described in U.S. Pat. No. 9,637,845 or elsewhere. In alternate embodiments, a protective or rash-guard fabric may be used, which may protect the wearer from damage caused by ultra-violet light, chafing and irritation of the skin, and provide some insulation and moisture wicking properties. Such materials are described in U.S. Patent Publication Nos. 2013/0239309 and 2009/0151041. In still other embodiments a material such as neoprene may be incorporated into the garment in order to enhance the buoyancy or insulating properties of the garment. In such embodiments, the neoprene may be, for example, 1 mm, 2 mm, 3 mm, 4 mm, and 5 mm in thickness.

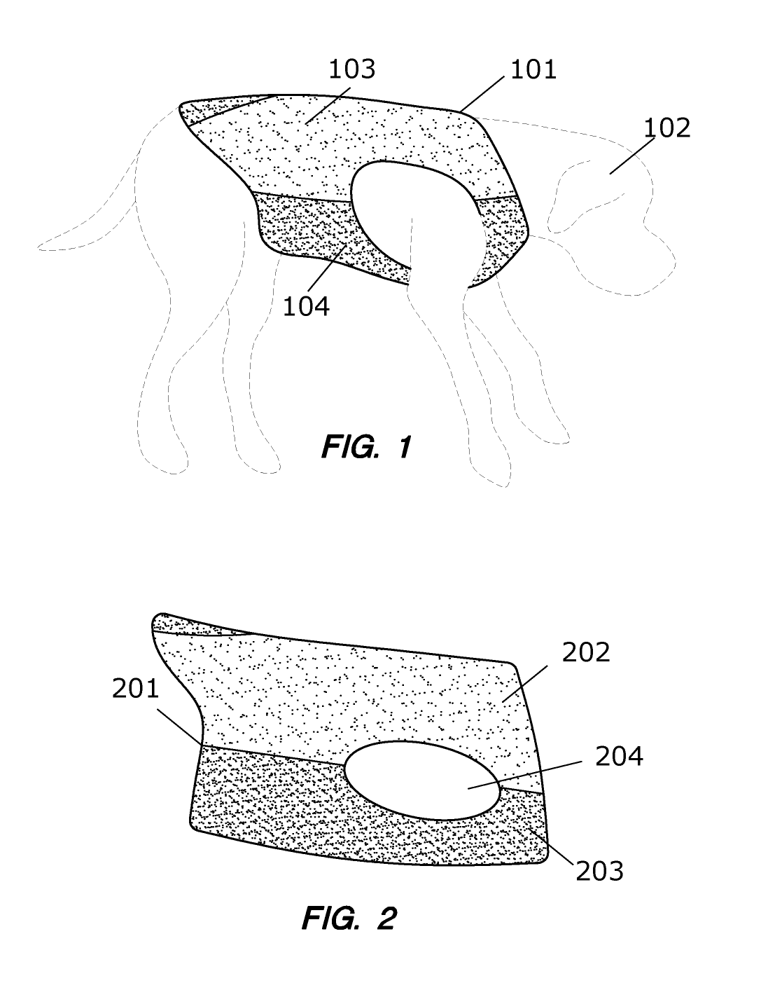

Turning now to the figures, exemplary embodiments of the present invention are described. FIG. 1 illustrates a lateral view of the garment (101) of the present invention as worn by a dog (102). Preferably, the garment of the present invention will be structured and sized such that it is substantially form-fitting, as shown in FIG. 1, and provides constant, gentle pressure to a substantial portion of the torso of animal. More preferably, the garment will be constructed of two different types of fabric. Preferably the dorsal portion of the garment will comprise a first fabric (103) which comprises a 2-way stretch Polyester Performance Knit fabric, which will preferably comprise a perforated surface to facilitate moisture wicking and airflow, as well as anti-microbial properties. Preferably the ventral portion of the garment will comprise a second fabric (104) which comprises a 4-way stretch Nylon and Spandex Mixed Performance Knit.

FIG. 2 illustrates a lateral view of one embodiment of the garment of the present invention without the presence of the animal. The seams (201) between the first fabric (202) and the second fabric (203) may be formed by sewing, stitching, gluing, taping, or other methods known in the art, and will vary based on the type of fabric used. Preferably, the garment will feature openings (204) near the front of the garment and positioned to accommodate the forelimbs of the animal.

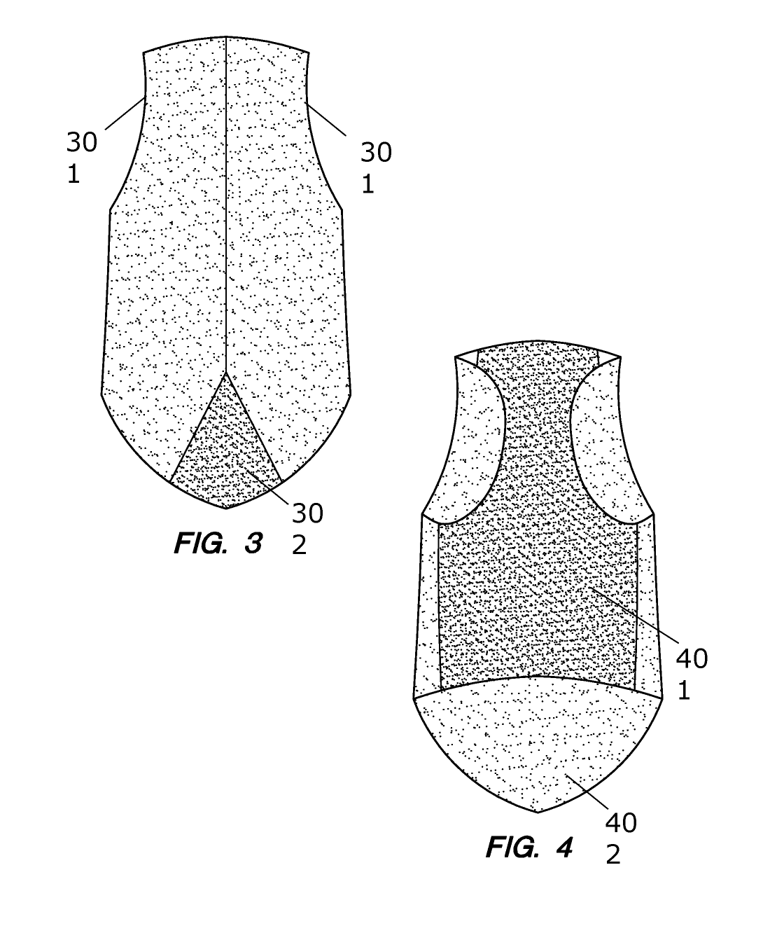

FIG. 3 illustrates a dorsal view of one embodiment of the garment of the present invention. It will be apparent to those having skill in the art that the dorsal and ventral portions of the garment may be constructed of multiple panels of fabric, as illustrated, or from a single panel. Preferably, the garment will be cut and sized in such a way that it is form fitting on the animal. Fore-limb openings (301) are illustrated here substantially near the front of the garment. Also illustrated is a V-shaped cutout (302) located in the rear portion of the garment, which is preferably included in the garment to prevent it from rolling up during normal wear. The V-shaped cutout (302) may be left empty, or may be filled in with an alternated fabric (such as the second fabric used in the garment) as illustrated.

FIG. 4 illustrates a ventral view of one embodiment of the garment of the present invention. Preferably, the ventral portion (401) of the garment will not extend as far along the torso of the animal as the dorsal portion (402), thus allowing freedom of movement of the animal's hind limbs.

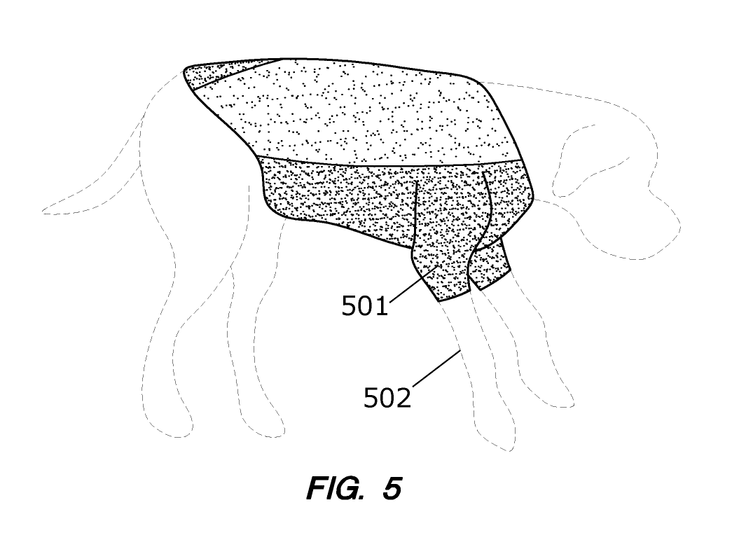

FIG. 5 illustrates an alternate embodiment of the present invention, in which the fore-limb openings comprise sleeves (501) which extend down a portion of the fore-limbs (502) of the animal. Such sleeves may be used in situations where one wishes to apply constant pressure to the shoulders or limbs of the animal, or in situations where the additional protection to the animal is desired.

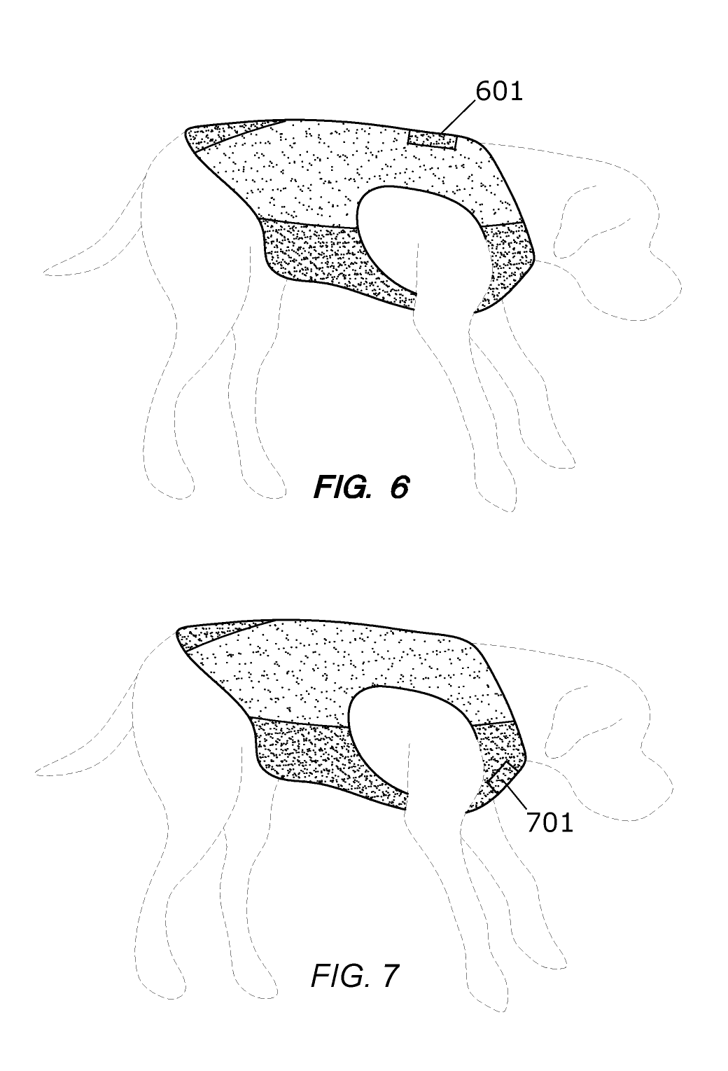

FIG. 6 illustrates an alternate embodiment of the present invention, which comprises an additional pocket (or similar receptacle) (601) on the dorsal portion of the garment which is configured to receive a locating device to track the location of the animal. Such devices include, but are not limited to, GPS based systems such as those described in U.S. Pat. Nos. 6,067,018, 6,172,640 and 6,236,358 and radio frequency location systems such as those described in U.S. Publication No. 2006/0038676, or other such systems which are known in the art. It will be apparent to one having skill in the art that the locating device may be integral, or “sewn in” to the garment, or it may be removable from the pocket. An alternate location (701) is illustrated in FIG. 7, where the receptacle is located on the chest area of the garment. It will be further apparent to those having skill in the art that the pocket may be placed at alternate locations around the garment. Furthermore, additional pockets may be placed on the garment allowing the animal to carry supplies or other cargo.

Numerous structures are disclosed herein. The components of the present invention also include any derivative components with a similar function. It is within the skill of the art to make derivative or alternate configurations using the disclosures of the present application and those that are incorporated by reference.

Methods and components are described herein. However, methods and components similar or equivalent to those described herein can be also used to obtain variations of the present invention. The materials, articles, components, methods, and examples are illustrative only and not intended to be limiting.

Although only a few embodiments have been disclosed in detail above, other embodiments are possible and the inventors intend these to be encompassed within this specification. The specification describes specific examples to accomplish a more general goal that may be accomplished in another way. This disclosure is intended to be exemplary, and the claims are intended to cover any modification or alternative which might be predictable to a person having ordinary skill in the art.

Having illustrated and described the principles of the invention in exemplary embodiments, it should be apparent to those skilled in the art that the described examples are illustrative embodiments and can be modified in arrangement and detail without departing from such principles. Techniques from any of the examples can be incorporated into one or more of any of the other examples. It is intended that the specification and examples be considered as exemplary only, with a true scope and spirit of the invention being indicated by the following claims.

I claim:

1: A form fitting, substantially tubular garment for an animal having a front end, a back end, a dorsal side, and a ventral side, said garment comprising:
i. a first fabric and a second fabric;
ii. wherein said dorsal side comprises said first fabric;
iii. wherein said first fabric comprises a material expandable in at least one dimension;
iv. wherein said ventral side comprises said second fabric; and
v. wherein said second fabric comprises a material expandable in at least two dimensions;
vi. wherein said front end of said garment comprises an opening to accommodate the head of said animal;
vii. wherein said ventral side of said garment further comprises openings substantially near the front end of said garment to accommodate the fore-limbs of said animal.

2: The garment of claim 1, wherein at least one of the material expandable in at least one dimension and the material expandable in at least two dimensions is resistant abrasive force.

3: The garment of claim 2, wherein at least one of the material expandable in at least one dimension and the material expandable in at least two dimensions is a rip-stop material.

4: The garment of claim 2, wherein at least one of the material expandable in at least one dimension and the material expandable in at least two dimensions is a rash-guard material.

5: The garment of claim 1, wherein at least one of the material expandable in at least one dimension and the material expandable in at least two dimensions is a moisture wicking material.

6: The garment of claim 1, wherein the garment applies a constant pressure to the animal.

7: The garment of claim 1, wherein the garment further comprises a pocket.

8: The garment of claim 7, wherein said pocket is configured to receive a locating device.

9: The garment of claim 1, wherein the garment lacks fasteners and pull-strings.

10: A method for reducing anxiety in an animal, the method comprising:
i. identifying an animal at risk of anxiety; and
ii. placing on said animal a form fitting, substantially tubular garment having a front end, a back end, a dorsal side, and a ventral side, said garment comprising:
a. a first fabric and a second fabric;
b. wherein said dorsal side comprises said first fabric;
c. wherein said first fabric comprises a material expandable in at least one dimension;
d. wherein said ventral side comprises said second fabric;
e. wherein said second fabric comprises a material expandable in at least two dimensions;
f. wherein said front end of said garment comprises an opening to accommodate the head of said animal; and
g. wherein said ventral side of said garment further comprises openings substantially near the front end of said garment to accommodate the fore-limbs of said animal.
